(19) United States
(12) Patent Application Publication
(10) Pub. No.: US 2021/0031691 A1
(43) Pub. Date: Feb. 4, 2021

(54) VEHICLE INTERIOR BLIND SPOT MIRROR

(71) Applicant: GM GLOBAL TECHNOLOGY OPERATIONS LLC, DETROIT, MI (US)

(72) Inventors: Mark Pulleyblank, Harrison Township, MI (US); Gino M. Le Donne, Lake Orion, MI (US)

(21) Appl. No.: 16/524,826

(22) Filed: Jul. 29, 2019

(51) Int. Cl. B60R 1/08; B60R 1/04; G02B 5/10

(52) U.S. Cl. CPC B60R 1/081; B60R 1/06; G02B 5/10; B60R 1/04

(57) ABSTRACT

An automotive vehicle includes a body having an interior and an exterior. The interior defines an occupant cabin. The body has a door frame defining a door opening. A vehicle door is coupled to the door frame and is movable between open and closed positions relative to the door frame. The vehicle door has an exterior side and an interior side. In the closed position the vehicle door covers the door opening with the interior side being disposed on the interior of the body. The vehicle additionally includes a window secured to the vehicle door. The vehicle also includes an outside rear-view mirror housing coupled to the exterior of the body. The vehicle further includes an inside rear-view mirror housing coupled to the interior of the body proximate the window and a reflective surface disposed in the inside rear-view mirror housing.

### INTRODUCTION

The present disclosure relates to mirror assemblies, and more particularly to mirror assemblies for automotive vehicles having enclosed occupant cabins.

Automotive vehicles may be provided with a variety of mirrored surfaces to assist drivers in viewing objects behind the vehicle. A conventional arrangement includes a driver-side outside rear-view mirror, a passenger-side outside rear-view mirror, and an inside rear-view mirror positioned along the centerline of the vehicle. However, such arrangements may result in so-called blind spots, referring to regions proximate the rear or sides of the vehicle which are not visible in the conventional mirror arrangement.

### SUMMARY

An automotive vehicle according to the present disclosure includes a body having an interior and an exterior. The interior defines an occupant cabin. The body has a door frame defining a door opening. A vehicle door is coupled to the door frame and is movable between open and closed positions relative to the door frame. The vehicle door has an exterior side and an interior side. In the closed position the vehicle door covers the door opening with the interior side being disposed on the interior of the body. The vehicle additionally includes a window secured to the vehicle door. The vehicle also includes an outside rear-view mirror housing coupled to the exterior of the body. The vehicle further includes an inside rear-view mirror housing coupled to the interior of the body proximate the window and a reflective surface disposed in the inside rear-view mirror housing.

In an exemplary embodiment, the vehicle door includes a frame extending about the window, and the inside rear-view mirror housing is coupled to the interior of the body at the frame. In some such embodiments, the inside rear-view mirror housing has a bottom surface, the frame has a lower edge, and the bottom surface of the inside rear-view mirror housing is spaced above the lower edge of the frame.

In an exemplary embodiment, the reflective surface includes a convex mirror.

In an exemplary embodiment, the inside rear-view mirror housing is generally in register with the outside rear-view mirror housing with the window disposed therebetween.

In an exemplary embodiment, the vehicle additionally includes an adjustor coupled to the reflective surface and configured to adjust a position of the reflective surface relative to the inside rear-view mirror housing. In some such embodiments, the reflective surface is coupled to the inside rear-view mirror housing via a living hinge.

In an exemplary embodiment, the vehicle additionally includes a windshield and a second inside rear-view mirror housing coupled to the windshield proximate a midline of the body.

A door assembly for an automotive vehicle according to the present disclosure includes a door. The door has an interior side, an exterior side, a window, and a frame extending about the window. The assembly additionally includes a mirror housing. The housing has a mirror enclosure portion and at least one attachment portion coupled to the frame at the interior side of the door proximate the window. The assembly further includes a reflective surface disposed in the mirror enclosure portion.

In an exemplary embodiment, the assembly additionally includes a second mirror housing coupled to the exterior side of the door proximate the window.

In an exemplary embodiment, the mirror housing has a bottom surface, the frame has a lower edge, and the bottom surface of the mirror housing is spaced above the lower edge of the frame.

In an exemplary embodiment, the assembly additionally includes an adjustor coupled to the reflective surface and configured to adjust a position of the reflective surface relative to the mirror housing. In such embodiments, the reflective surface may be coupled to the mirror housing via a living hinge.

In an exemplary embodiment, the at least one attachment portion includes a tab member, and the assembly includes an interior trim panel superposed over the tab member.

Embodiments according to the present disclosure provide a number of advantages. For example, the present disclosure provides an additional mirror arranged to provide increased visibility to potential blind spots proximate the vehicle. Moreover, the present disclosure does so without impeding side air curtain air bags or other devices, while also facilitating airflow for defogging purposes.

The above advantage and other advantages and features of the present disclosure will be apparent from the following detailed description of the preferred embodiments when taken in connection with the accompanying drawings.

### BRIEF DESCRIPTION OF THE DRAWINGS

The disclosed examples will hereinafter be described in conjunction with the following drawing figures, wherein like numerals denote like elements, and wherein:

FIG. 1 is a schematic representation of an automotive vehicle according to an embodiment of the present disclosure;

FIG. 2 is an isometric view of a mirror assembly within a cabin of an automotive vehicle according to an embodiment of the present disclosure;

FIG. 3 is an exploded view of a mirror assembly according to an embodiment of the present disclosure;

FIG. 4 is a left side view of a mirror assembly according to an embodiment of the present disclosure;

FIG. 5 is a cross-section along A-A in FIG. 4;

FIG. 6 is a right side view of a mirror assembly according to an embodiment of the present disclosure;

FIG. 7 is a cross-section along B-B in FIG. 6; and

FIG. 8 is a side view of a mirror assembly within a cabin of an automotive vehicle according to an embodiment of the present disclosure.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

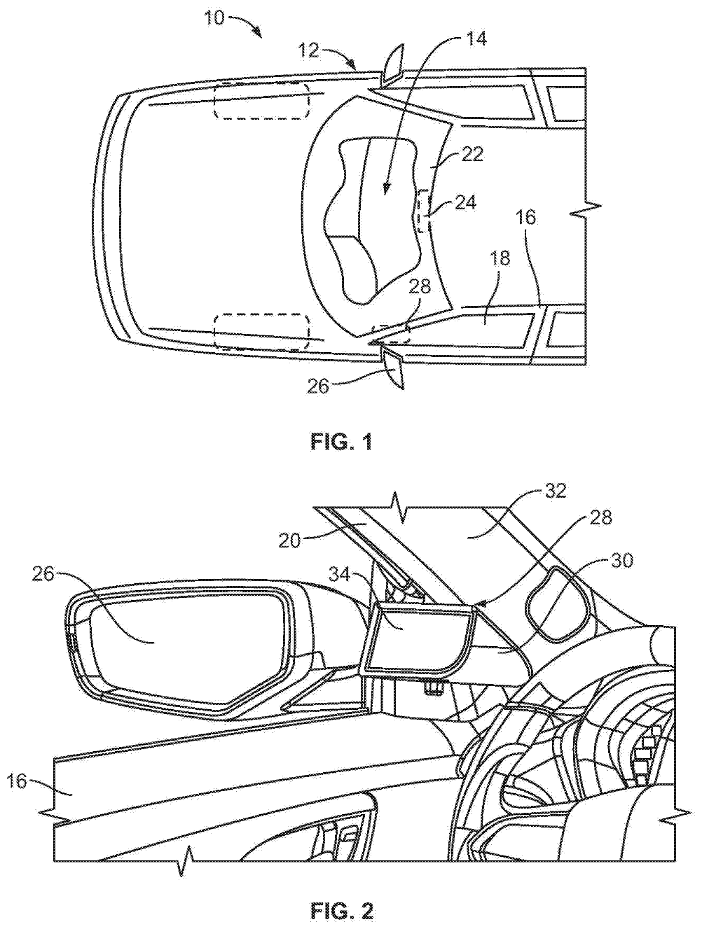

Referring now to FIGS. 1 and 2, an automotive vehicle 10 according to the present disclosure is illustrated. The vehicle 10 has a body 12 having an exterior and an interior. The body 12 may be of any suitable shape, size, or configuration, according to the intended purpose and styling of the vehicle 10.

The interior of the body 12 defines an occupant cabin 14. The occupant cabin 14 is configured to securely enclose one or more occupants. Conventionally, one front seat in the occupant cabin 14 is designated as a driver's seat. According to local driving rules, the driver's seat may be positioned on either side of the occupant cabin 14. In the illustrated embodiment and as discussed below, the driver's seat will be considered to be on the left side of the occupant cabin 14; however, one of ordinary skill in the art will appreciate that the teachings herein may likewise be adapted to a driver's seat on the right side of the occupant cabin 14.

The body 12 is provided with at least one closure 16, which may be referred to as door, disposed in a closure frame, which may be referred to as a door frame. The door frame extends about an opening from the exterior of the body 12 to the interior of the body 12. The door 16 is coupled to the body 12 and movable between an open position and a closed position. When in the open position the opening is exposed to facility ingress or egress from the occupant cabin 14, and when in the closed position the door 16 covers the opening.

The door 16 is provided with at least one window 18. In the illustrated embodiment, the door 16 is provided with a window frame 20 extending about the window 18; however, in alternative embodiments, e.g. convertible vehicles, no window frame 20 may be provided.

The vehicle 10 is additionally provided with a windshield 22 at the fore of the occupant cabin 14. An inside rear-view mirror (“ISRVM”) 24 is coupled to an interior surface of the windshield 22 to enable an occupant in the driver's seat of the occupant cabin 14 to view objects behind the body 12. The ISRVM 24 may be positioned generally along a centerline of the body 12. The ISRVM 24 may be arranged in any suitable fashion, e.g. as a conventional mirror or a display monitor configured to display video from a camera oriented aftward of the vehicle.

An outside rear-view mirror (“OSRVM”) 26 is provided on the exterior of the body 12 proximate the window 18, e.g. coupled to an exterior portion of the door 16. The OSRVM 26 is provided to enable an occupant in the driver's seat of the occupant cabin 14 to view objects behind and to the side of the body 12. The OSRVM 26 may be arranged in any suitable fashion, e.g. as a conventional mirror or a display monitor configured to display video from a camera oriented aftward of the vehicle.

A side inside rear-view mirror (“SISRVM”) 28 is provided in the occupant cabin 14 proximate the window 18, generally in register with the OSRVM 26. The SISRVM 28 includes a SISRVM housing 30 coupled to the interior of the occupant cabin 14. In the illustrated embodiment, the SISRVM housing 30 is coupled to the window frame 20, as will be discussed in further detail below. However, in other embodiments, the SISRVM housing 30 may be coupled to other portions of the occupant cabin which would not inhibit driver forward or rearward vision, e.g. to a so-called sail panel of the door 16, or an A-pillar 32 of the body 12. Such alternate embodiments enable use of the SISRVM 28 in vehicles which lack a full window frame, such as convertibles.

The SISRVM 28 is provided with a reflective surface 34. In an exemplary embodiment the reflective surface 34 comprises a convex mirrored surface; however, in other embodiments other reflective surfaces may be employed, such as a planar mirror. Various materials may be used to form the reflective surface 34, including glass, polycarbonate, or other suitably transparent material. In still other embodiments, a display screen may be employed in place of the reflective surface. In such embodiments, the display screen may be configured to display images from a blind spot camera or other suitable images.

Configured thusly, the SISRVM 28 enables a driver to view both the OSRVM 26 and the reflective surface 34, and thereby track vehicles or other objects as they pass between the respective fields of view of the OSRVM 26 and the SISRVM 28. Moreover, the reflective surface 34 has a clear field of view to a blind spot of the vehicle 10, unimpeded by any body pillars, trim panels, or other visible obstructions. Furthermore, because the SISRVM 28 is positioned within the cabin, it is protected from precipitation, debris, or other environmental factors which could affect visibility of the reflective surface 34.

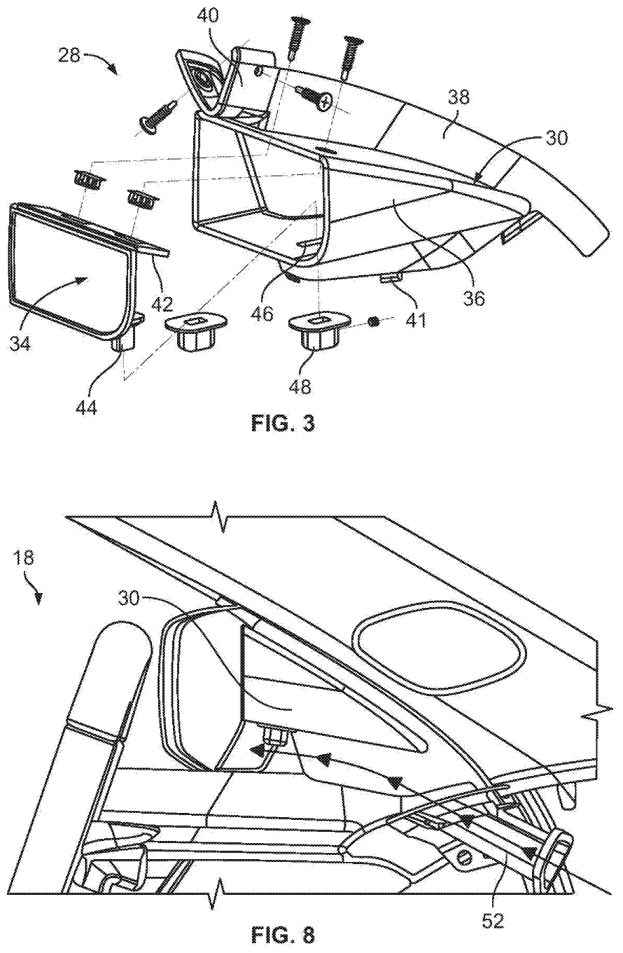

Referring now to FIG. 3, the SISRVM 28 is shown in further detail. The SISRVM housing 30 comprises a mirror enclosure portion 36, a trim portion 38, an upper attachment portion 40, and a lower attachment portion 41. The mirror enclosure portion 36 defines a generally hollow cavity within which the reflective surface 34 is retained. The trim portion 38 provides desired styling proximate the SISRVM 28, e.g. by wrapping about the window frame 20 and/or a sail panel of the door 16. The upper attachment portion 40 and lower attachment portion 41 provide means to fix the upper and lower portions, respectively, of the SISRVM housing 30 to the window frame 20 or other fixation location of the body 12. In the illustrated embodiment the upper attachment portion 40 comprises fastener holes for receiving one or more fasteners; however, in other embodiments the upper attachment portion 40 may comprise other attachment features, e.g. molded clips or other fixation means. In the illustrated embodiment the lower attachment portion 41 comprises a plurality of molded tabs; however, in other embodiments the lower attachment portion 41 may comprise other attachment features.

In the illustrated embodiment, the reflective surface 34 is provided with a living hinge 42 at an upper region of the reflective surface 34 and an adjuster 44 at a lower region of the reflective surface 34. The living hinge 42 is coupled to the interior of the mirror enclosure portion 36, e.g. by fasteners as illustrated here or by other suitable attachment features. The adjustor 44 extends through a slot 46 in the mirror enclosure portion 36 and is provided with a knob 48. An operator may slide the knob relative to the slot 46 to adjust a position of the reflective surface 34 relative to the SISRVM housing 30. Advantageously, such a configuration provides secure 3-point attachment between the reflective surface 34 and the SISRVM housing 30, while also enabling suitable adjustment of the reflective surface 34.

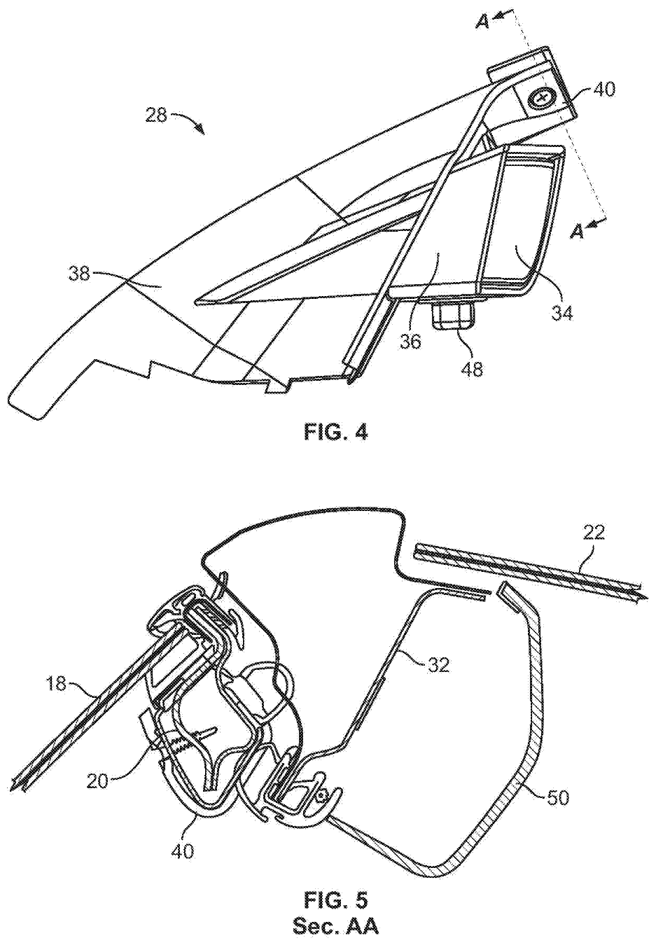

Referring now to FIGS. 4 and 5, the attachment of the upper attachment portion 40 of the SISRVM housing 30 to the window frame 20 is illustrated in further detail. FIG. 4 illustrates a left view of the SISRVM housing 30, and FIG. 5 illustrates a cross-section taken along A-A in FIG. 4. Advantageously, in the illustrated configuration, side air curtain air bags or other devices may be secured between the A pillar 32 and an A pillar trim panel 50. Such devices may thereby be activated without interference from the SISRVM 28. As an example, side curtain air bags secured between the A pillar 32 and the A pillar trim panel 50 may deploy around the SISRVM 28, and preferably secure the reflective surface 34 within the SISRVM housing 30.

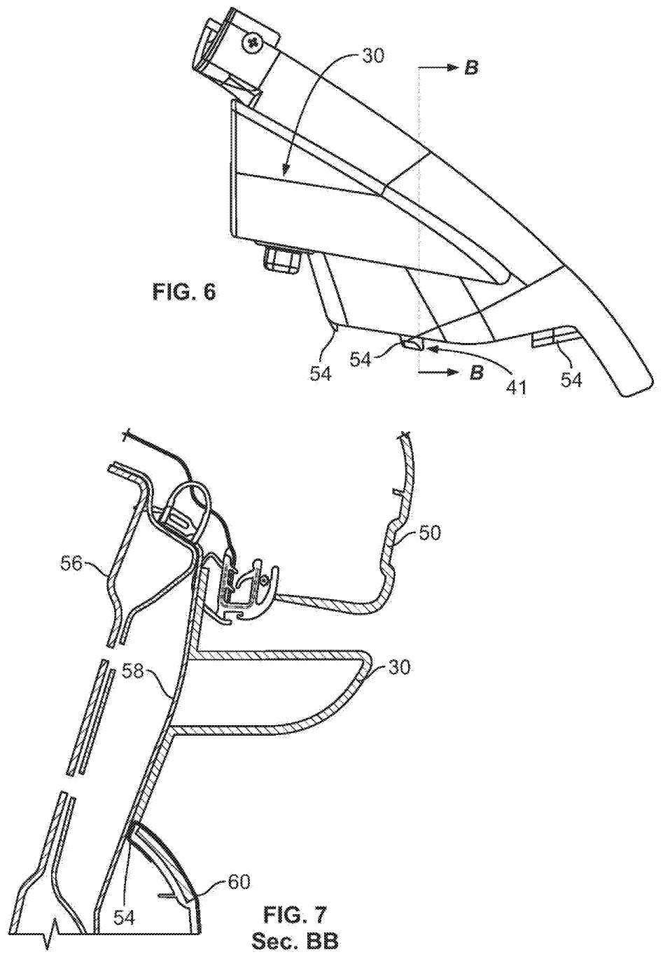

Referring now to FIGS. 6 and 7, the attachment of the lower attachment portion 41 of the SISRVM housing 30 to the window frame 20 is illustrated in further detail. FIG. 6 illustrates a right view of the SISRVM housing 30, and FIG. 7 illustrates a cross-section taken along B-B in FIG. 6. In the illustrated embodiment, the lower attachment portion 41 comprises a plurality of molded tabs 54. While three tabs 54 are illustrated, in other embodiments a different number of tabs may be used. As may be seen in FIG. 7, the door frame 56 is covered by an upper trim panel 58 and a lower trim panel 60. The upper trim panel 58 is abutted by the SISRVM housing 30, tabs 54 are secured between the lower trim panel 60 and the upper trim panel 58. Relative movement between the lower attachment portion 41 and the door frame 56 is thereby constrained in longitudinal and lateral directions, while relative motion in the vertical direction is constrained via the fixation of the upper attachment portion 40.

Referring now to FIG. 8, window a de-fogging vent 52 is illustrated. Advantageously, air (depicted by the arrows) is directed from the de-fogging vent 52 along a bottom surface of the SISRVM housing 30 to the window 18. The efficacy of the de-fogging vent may thereby be maintained or increased.

As may be seen, the present disclosure provides an additional mirror arranged to provide increased visibility to potential blind spots proximate the vehicle. Moreover, the present disclosure does so without impeding side air curtain air bags or other devices, while also facilitating airflow for defogging purposes.

As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. An automotive vehicle comprising:
a body having an interior and an exterior, the interior defining an occupant cabin, the body having a door frame defining a door opening and a vehicle door coupled to the door frame, the vehicle door being movable between open and closed positions relative to the door frame, the vehicle door having an exterior side and an interior side, wherein in the closed position the vehicle door covers the door opening with the interior side being disposed on the interior of the body;
a window secured to the vehicle door;
an outside rear-view mirror housing coupled to the exterior of the body;
an inside rear-view mirror housing coupled to the interior of the body proximate the window; and
a reflective surface disposed in the inside rear-view mirror housing.

2. The automotive vehicle of claim 1, wherein the vehicle door comprises a frame extending about the window, and wherein the inside rear-view mirror housing is coupled to the interior of the body at the frame.

3. The automotive vehicle of claim 2, wherein the inside rear-view mirror housing has a bottom surface, the frame has a lower edge, and wherein the bottom surface of the inside rear-view mirror housing is spaced above the lower edge of the frame.

4. The automotive vehicle of claim 1, wherein the reflective surface comprises a convex mirror.

5. The automotive vehicle of claim 1, wherein the inside rear-view mirror housing is generally in register with the outside rear-view mirror housing with the window disposed therebetween.

6. The automotive vehicle of claim 1, further comprising an adjustor coupled to the reflective surface and configured to adjust a position of the reflective surface relative to the inside rear-view mirror housing.

7. The automotive vehicle of claim 6, wherein the reflective surface is coupled to the inside rear-view mirror housing via a living hinge.

8. The automotive vehicle of claim 1, further comprising a windshield and a second inside rear-view mirror housing coupled to the windshield proximate a midline of the body.

9. A door assembly for an automotive vehicle comprising:
a door having an interior side, an exterior side, a window, and a frame extending about the window;
a mirror housing having a mirror enclosure portion and at least one attachment portion coupled to the frame at the interior side of the door proximate the window; and
a reflective surface disposed in the mirror enclosure portion.

10. The door assembly of claim 9, further comprising a second mirror housing coupled to the exterior side of the door proximate the window.

11. The door assembly of claim 9, wherein the mirror housing has a bottom surface, the frame has a lower edge, and wherein the bottom surface of the mirror housing is spaced above the lower edge of the frame.

12. The door assembly of claim 9, further comprising an adjustor coupled to the reflective surface and configured to adjust a position of the reflective surface relative to the mirror housing.

13. The door assembly of claim 12, wherein the reflective surface is coupled to the mirror housing via a living hinge.

14. The door assembly of claim 9, wherein the at least one attachment portion comprises a tab member, the assembly further comprising an interior trim panel superposed over the tab member.
